(19) United States
(12) Patent Application Publication
(10) Pub. No.: US 2016/0333924 A1
(43) Pub. Date: Nov. 17, 2016

(54) Swivel

(71) Applicant: Jorge R. Aviles, Miami, FL (US)

(72) Inventor: Jorge R. Aviles, Miami, FL (US)

(73) Assignee: Heyssel T. Lopez, Miami, FL (US)

(21) Appl. No.: 14/545,237

(22) Filed: Apr. 13, 2015

(51) Int. Cl. F16C 11/10; B25G 1/06

(52) U.S. Cl. CPC F16C 11/106; B25G 1/06

(57) ABSTRACT

The invention provides a Swivel apparatus for affixing paint roller handles with a paint roller extension pole, for maneuvering around hard to reach areas of a ceiling, wall or floor. This apparatus provides the operator with ease in convenience as it relates to maneuvering and mobility. The attachment consists of a tubular member, a cup-socket formation, an hexagonal shaped tightening nut which will allow the apparatus to be easily changed in order to reach those difficult spots and smallest corners. The Swivel can be adjusted or adapted to all size rollers in order to finish all surfaces. The apparatus will have a pressure locking screw mechanism to affix the joint at any degree angle which may be needed. Each end of the Swivel joint will have standard male and female ends to allow a paint roller and a paint roller extension pole to be affixed easily.

### BACKGROUND OF THE INVENTION

1. Field of the Invention

The present invention relates generally to a Swivel apparatus for affixing paint roller handles with a paint roller extension pole, for maneuvering around hard to reach areas of a ceiling, wall or floor. This innovative swivel provides the operator with ease in convenience as it relates to maneuvering and mobility. The attachment can be easily changed in order to reach those difficult spots and smallest corners. The Swivel can be easily adjusted or adapted to all size rollers in order to finish all surfaces. The Swivel will have a pressure locking screw mechanism to affix the joint at any degree angle which may be needed by the user. Each end of the Swivel joint will have standard male and female ends to allow a paint roller and a paint roller extension pole to be affixed easily.

### BRIEF DESCRIPTION OF THE DRAWINGS

FIG. 1 is an elevational view which shows the Swivel apparatus with a male pipe end on top and a female pipe end on the bottom. It also shows the flexible ball elbow joint which is affixed to the hex nut pressure locking mechanism.

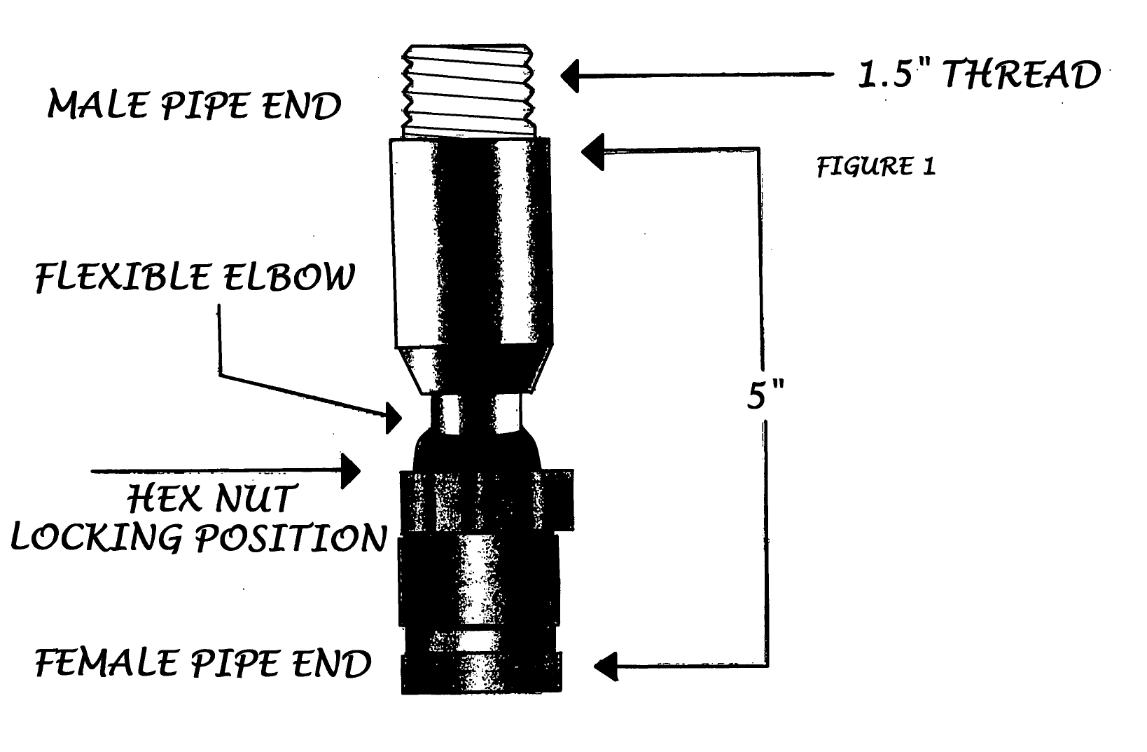

FIG. 2 points out the hex nut which, upon tightening, locks the socket with pressure on the ball. This will enable the joint to remain fixed once the desired angle is selected.

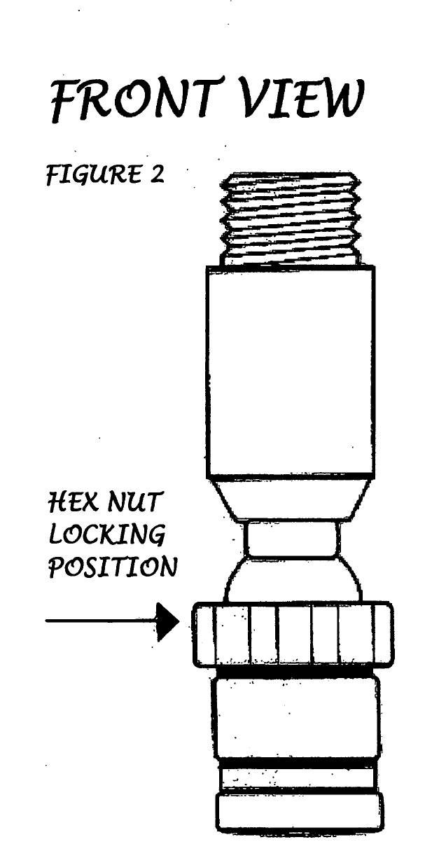

FIG. 3 merely illustrates the full 180 degree range of motion the Swivel will allow the user to utilize.

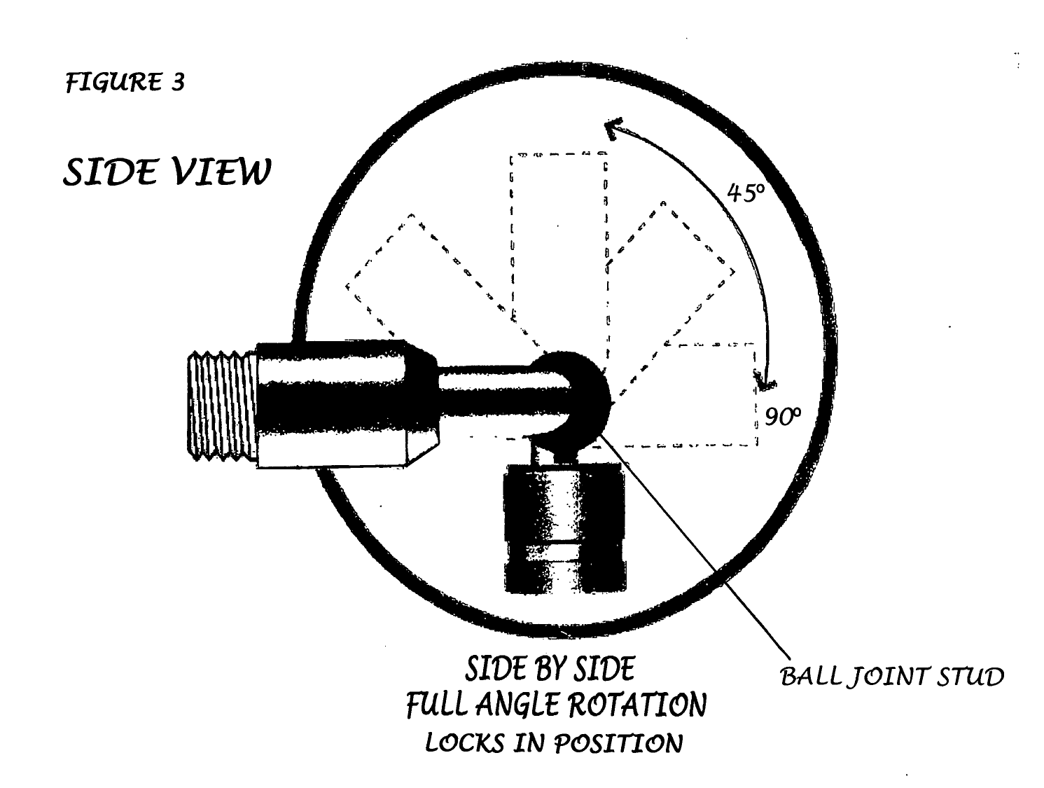

FIG. 4 illustrates the Swivel assembly joint as it pertains to how it relates with the paint roller and a regular paint roller extension pole.

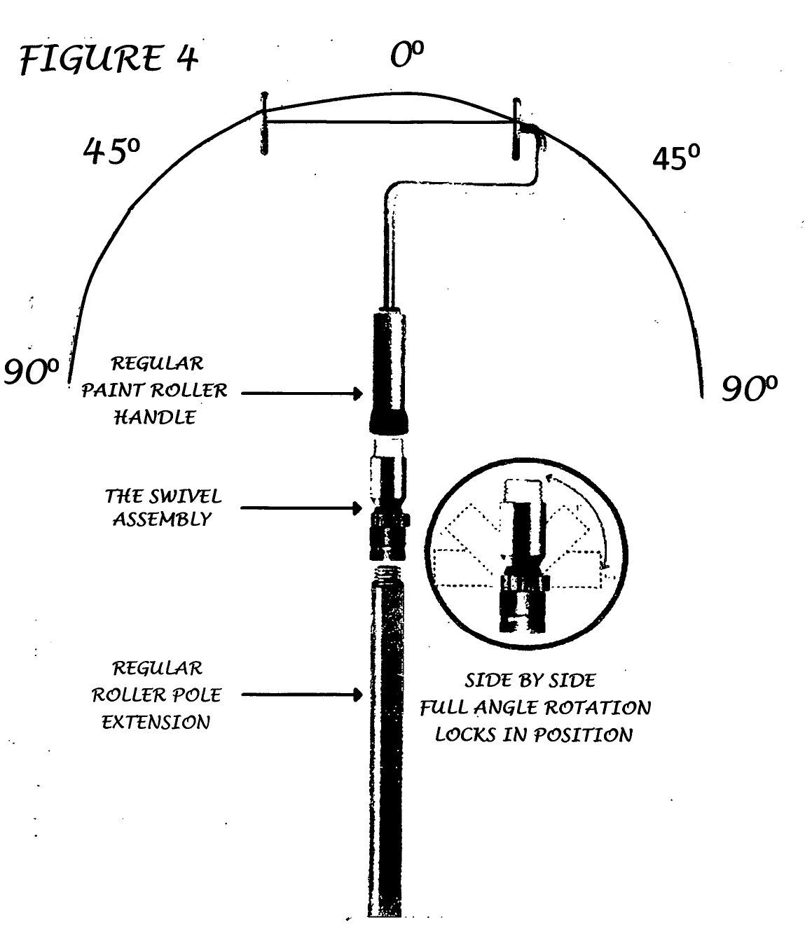

### SUMMARY OF THE INVENTION

It has been recognized that it would be advantageous to develop a swivel joint mechanism to affix a paint roller with a paint roller extension pole. One of the problems of painting walls, ceilings and floors is that sometimes areas are difficult to reach due to house design, obstacles and other situations where by a straight extension pole will not suffice to do the job properly. The swivel joint mechanism will be comprised of a ball-and joint connection which permits coaxial rotation in several axes. It also comprises a hex nut pressure locking screw mechanism. The swivel will also be comprised, at each end, of male and female threaded screws which will enable the Swivel to be fixed to the paint roller and paint extension pole. It is intended that the Swivel will be constructed of a thermoplastic material, however flexible metal could be used in place of the thermoplastic material.

This innovative swivel provides the operator with ease in convenience as it relates to maneuvering and mobility. The attachment can be quickly changed in order to reach those tough areas and smallest corners. The Swivel can be easily adjusted or adapted to all size rollers in order to finish all surfaces.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The Swivel adjusting section consists of a tubular member of: suitable length and designed to fit within standard paint roller and paint roller extension pole in a vertically adjusted position, the latter being obtained through the positioning of the member and then tightening the set hex nut locking member. The lower end of swivel joint mechanism is formed into a cup or socket like area in which to affix the ball member. The ball member should be constructed of a hard thermal plastic yet be preferably of sufficient elasticity to allow their expansion and contraction of the ball member to allow movement of the Swivel joint to its preferred positions.

Below the cup-socket formation is a portion of the member body designed to have female thread, which is unexposed, to allow a regular paint roller extension pole to be fixed. Above the pipe formation attached to the ball member is a male thread, which is exposed, to allow a standard paint roller to be fixed.

Surrounding the cup socket formation is an hexagonal shaped tightening nut , the length of which is such as to overlie the thread zone and extend over the ball member Internally, the hexagonal nut is threaded to tighten said cup socket over the said ball member. The nut is threaded to apply pressure on the ball member, the inner hexagonal nut will have a tight gripping engagement with the ball, such engagement preventing any movement of the ball within the socket.

The cup socket member formation is designed to receive the ball member. It will be understood that because of the ball and cup socket formation, the paint roller connected section is tiltable throughout a range of 180 degrees and to rotate 360 degrees whenever hexagonal nut is loosened sufficient to free the ball member; also that the nut is movable sufficiently to allow the passage of the ball through the open top of the cup socket member. By design, the maximum tilting range is approximately 90 degrees on each side of the vertical. Thus controlling the maximum angle to the vertical at which the paint roller head may extend.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

I claim as my invention:

1. A swivel joint mechanism for a paint roller and paint extension pole comprising of:
a. A cup socket member with female threads (bottom).
b. A ball member with pipe having male threads (top).
c. A hex nut locking member contacting with the outer side of said cup socket member for retaining Swivel joint in preferred position.
